(19) United States
(12) Patent Application Publication
(10) Pub. No.: US 2013/0242570 A1
(43) Pub. Date: Sep. 19, 2013

(54) LIGHT-EMITTING DEVICE

(71) Applicant: LEXTAR ELECTRONICS CORP., HSINCHU (TW)

(72) Inventors: CHUN-KUANG CHEN, TAIPEI CITY (TW); FENG-LING LIN, PINGTUNG COUNTY (TW); PO-SHEN CHEN, NEW TAIPEI CITY (TW); HUI-YING CHEN, CHANGHUA COUNTY (TW)

(73) Assignee: LEXTAR ELECTRONICS CORP., HSINCHU (TW)

(21) Appl. No.: 13/716,141

(22) Filed: Dec. 15, 2012

(30) Foreign Application Priority Data
Mar. 14, 2012 (TW) 101108675

(51) Int. Cl. F21V 15/01

(52) U.S. Cl. CPC F21V 15/01
USPC 362/362

(57) ABSTRACT

A light-emitting device includes a lower housing, a supporting frame, a light-emitting component, and an upper housing. The lower housing has a capacious recess and a pair of first fastening parts. The capacious recess is located between the first fastening parts. The supporting frame is disposed in the capacious recess. The light-emitting component is disposed on the supporting frame. The upper housing has a pair of second fastening parts. The second fastening parts and the first fastening parts are fastened each other, so that the upper housing covering the supporting frame and the light-emitting component is combined with the lower housing.

### BACKGROUND OF THE INVENTION

1. Field of the Invention

The present invention relates to a light-emitting device; in particular, to a light-emitting device which can reduce the difficulty of assembling.

2. Description of Related Art

A light emitting diode (LED) tube is a kind of lighting which is employed the LED as a light source. Some conventional LED tube not only includes a light bar having a plurality of LEDs, but also includes a supporting board for installation of the light bar, a upper housing, and a lower housing, in which the upper housing and the lower housing both cover the supporting board and the light bar, as shown in FIG. 1A.

FIG. 1A illustrates a perspective view of a conventional LED tube. Referring to FIG. 1A, a conventional LED tube 100 includes a light bar 110, a supporting board 120, an upper housing 132, and a lower housing 134. The light bar 110 has a plurality of LEDs 112 and is disposed on the supporting board 120. The supporting board 120 is disposed in the lower housing 134. The upper housing 132 covers the light bar 110 and the supporting board 120, and is combined with the lower housing 134 by an adhesive.

FIG. 1B illustrates a explode view of the LED tube in FIG. 1A. Referring to the FIG. 1A and FIG. 1B, the lower housing 134 has a pair of lateral slots 51 and a recess 134r. The lateral slots 51 are exposed on the inside of the recess 134r and opposite to each other. Both the lateral slots 51 and the recess 134r extend along a long-axis direction D1 of the LED tube 100. Two opposite sides of the supporting board 120 can insert into the lateral slots Si respectively so that the supporting boards 120 can be configured in the recess 134r of the lower housing 134.

In the common assembling process of LED tube 100, the light bar 110 is installed on the supporting board 120 first. Next, insert the two opposite sides of the supporting board 120 into the lateral slots Si in the long-axis direction D1, so as to finish the assembly of the supporting board 120 and the lower housing 134. Then, stick the upper housing 132 and the lower housing 134 together so that the light bar 110 and the supporting board 120 are covered by the upper housing 132. So far, the LED tube 100 is complete.

However, the previous assembling process in actual progress sometimes encounters difficulty, especially when assembling the supporting board 120 and the lower housing 134. Specifically, variations in process parameter occurs when producing the supporting board 120 and the lower housing 134. The sizes and the shapes of both the supporting board 120 and the lower housing 134 do not fit each other because of the previous variations in process parameter. Therefore, it is difficult to insert the supporting board 120 into the lateral slots Si.

Based on the above, the unfitness of both the size and the shape easily causes that the LED tube 100 is formed with a longer length L1. If the length L1 of the LED tube 100 is to long, the supporting board 120 in the assembling process is easy to be stuck in the lateral slots S1, and it increases the difficulty of assembling the supporting board 120 and the lower housing 134. Even, it is possible to cause the situation that the supporting board 120 and the lower housing 134 can not be assembled.

### SUMMARY OF THE INVENTION

The present invention provides a light-emitting device to reduce the previous difficulty of assembling the supporting board and the lower housing.

In order to achieve the aforementioned objects, according to an embodiment of the present invention, a light-emitting device includes a lower housing, a supporting frame, a light-emitting component, and an upper housing. The lower housing has a capacious recess and a pair of first fastening parts, in which the capacious recess is located between the first fastening parts. The supporting frame includes a disposing region for the light-emitting component and a holding part located except the disposing region. The supporting frame is disposed in the capacious recess. The light-emitting component is disposed on the disposing region. The upper housing has a pair of second fastening parts. The first fastening parts and the second fastening parts are fastened each other so the upper housing covers the supporting frame and the light-emitting component.

The supporting frame may include a pair of inserting members or a pair of hookers, and the lower housing may include a pair of inserting slots or a pair of fastening slots. By the insertion of the inserting members in the inserting slots or fastening between the hookers and the fastening slots, the supporting frame can be combined with the lower housing. It makes assembling the supporting frame and the lower housing simple and easy, thereby reducing the difficulty of assembling.

In order to further the understanding regarding the present invention, the following embodiments are provided along with illustrations to facilitate the disclosure of the present invention.

### BRIEF DESCRIPTION OF THE DRAWINGS

FIG. 1A illustrates a perspective view of a common LED tube.

FIG. 1B illustrates a explode view of the LED tube in FIG. 1A.

FIG. 2A illustrates a perspective view of a light-emitting device according to the first embodiment of the invention.

FIG. 2B illustrates a explode view of the light-emitting device in FIG. 2A.

FIG. 3A illustrates a perspective view of a light-emitting device according to the second embodiment of the invention.

FIG. 3B illustrates a explode view of the light-emitting device in FIG. 3A.

### DETAILED DESCRIPTION OF THE PREFERRED EMBODIMENTS

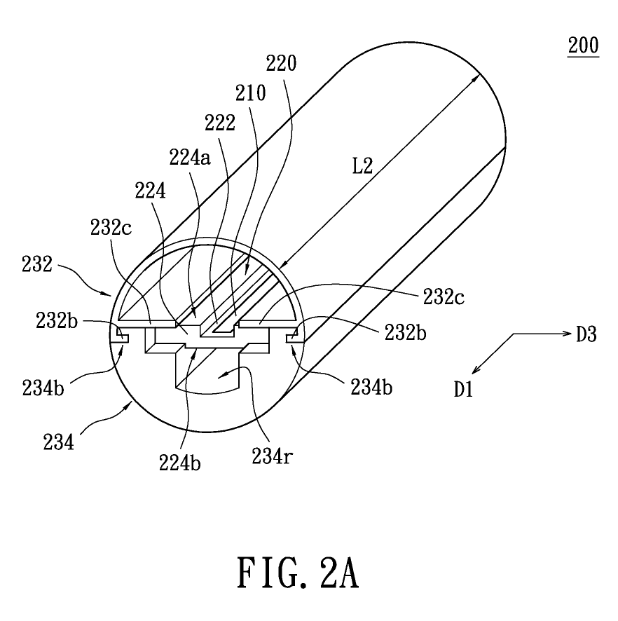

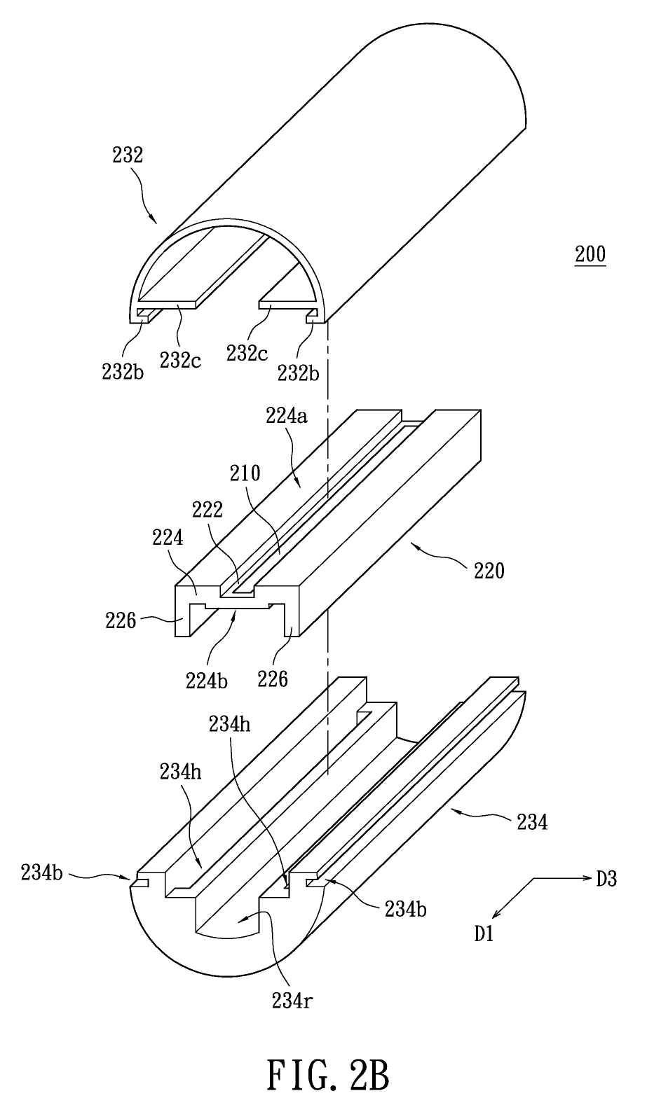

FIG. 2A illustrates a perspective view of a light-emitting device according to the first embodiment of the invention, and FIG. 2B illustrates a explode view of the light-emitting device in FIG. 2A. Referring to FIG. 2A and FIG. 2B, a light-emitting device 200 in the embodiment includes a light-emitting component 210, a supporting frame 220, an upper housing 232, and a lower housing 234. The light-emitting component 210 is disposed on the supporting frame 220. The upper housing 232 and the lower housing 234 can be combined together.

Specifically, the light-emitting component 210 may be a light bar containing a plurality of LEDs (not shown). The supporting frame 220 includes a disposing region 222 for the light-emitting component 210 and a holding part 224 located except the disposing region 222, in which the light-emitting component 210 is disposed on the disposing region 222. The disposing region 222 is inward in the surface of the holding part 224 and the recess region of the supporting frame 220. The light-emitting component 210 is located in the recess region.

The lower housing 234 has a capacious recess 234r, a pair of inserting slots 234h, and a pair of first fastening parts 234b. The supporting frame 220 further includes a pair of inserting members 226. The inserting members 226 all extend downward from both sides of the holding part 224. Specifically, the holding part 224 has an upper surface 224a and a lower surface 224b opposite to the upper surface 224a. The disposing region 222 is exposed on the upper surface 224a. The inserting member 226 all protrude from the lower surface 224b, but not from the upper surface 224a. Thus, the inserting members 226 only extend downward from the lower surface 224b.

The inserting members 226 correspond to the inserting slot 234h respectively and are inserted in the inserting slots 234h separately. By the insertion of the inserting members 226 in the inserting slots 234h, the supporting frame 220 can be fixed in the capacious recess 234r. By the insertion of the inserting members in the inserting slots or fastening between the hookers and the fastening slots. Therefore, the supporting frame 220 can be installed in the capacious recess 234r. In addition, the capacious recess 234r may be located between two first fastening parts 234b, and the inserting slots 234h may be parallel to each other in the region between the capacious recess 234r and the pair of the first fastening parts 234b.

The pair of the first fastening parts 234b is used to combine the upper housing 232 and the lower housing 234 together. In detail, the first fastening part 234b is such as fastening slot, and the upper housing 232 has a pair of second fastening parts 232b, such as hooker. The second fastening part 232b can be inserted in the first fastening part 234b so the second fastening parts 232b and the first fastening parts 234b are fastened each other.

Accordingly, because the second fastening parts 232b and the first fastening parts 234b are fastened each other, the upper housing 232 and the lower housing 234 can be combined together so the upper housing 232 can cover the supporting frame 220 and the light-emitting component 210. Therefore, the upper housing 232 and the lower housing 234 can cover the light-emitting component 210 and the supporting frame 220. In addition, the upper housing 232 may further has a pair of pressing parts 232c used for pressing the holding part 224 of the supporting frame 220. After the second fastening parts 232b and the first fastening parts 234b are fastened each other, the pressing parts 232c press the holding parts 224 respectively, as shown in FIG. 2A.

In the embodiment, the light-emitting device 200 may be a tube employed LEDs. The light-emitting device 200 may be in the shape of a bar. Thus, the shapes of both the upper housing 232 and the lower housing 234 can fit the shape of the light-emitting device 200 so that the upper housing 232 and the lower housing 234 are each in the shape of a bar. Hence, any one of the light-emitting device 200, the upper housing 232, and the lower housing 234 has a long axis and a short axis. The direction D1 of the long axis is perpendicular to the short-axis direction D3 of the short axis. The upper housing 232 and the lower housing 234 all extend along the direction D1 of the long axis of the light-emitting device 200.

Referring to FIG. 2B, besides the upper housing 232 and the lower housing 234, the light-emitting component 210 and the supporting frame 220 are each in the shape of a bar. The light-emitting component 210 and the supporting frame 220 also extend along the direction D1. Moreover, in view of shape, the first fastening parts 234b, the second fastening part 232b, the capacious recess 234r, the inserting slot 234h, the inserting member 226, and the disposing region 222 all extend along the direction D1 of the long axis.

Since the inserting members 226 all extend downward from the lower surface 224b and are inserted in the inserting slots 234h of the lower housing 234 respectively, the supporting frame 220 is fixed in the capacious recess 234r. Thus, comparing with prior art, the assembly between the supporting frame 220 and the lower housing 234 is simpler and easier. Furthermore, in the process for assembling the supporting frame 220 and the lower housing 234, even if the length L2 of the light-emitting device 200 is to long, the supporting frame 220 is not easy to be stuck in the inserting slot 234h.

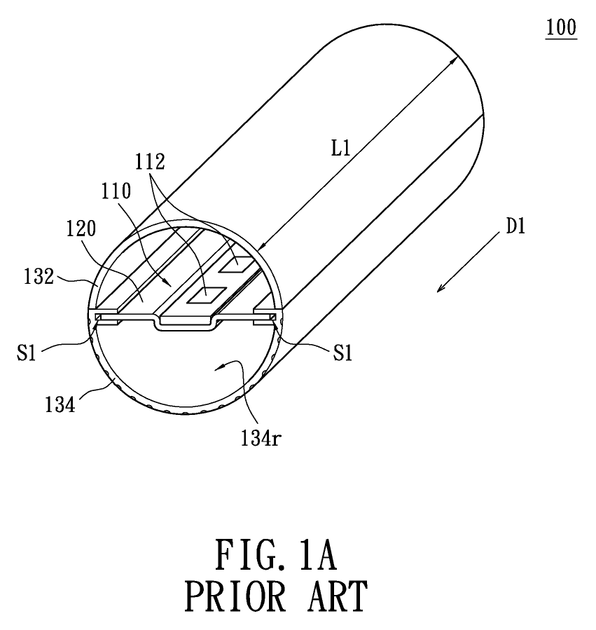

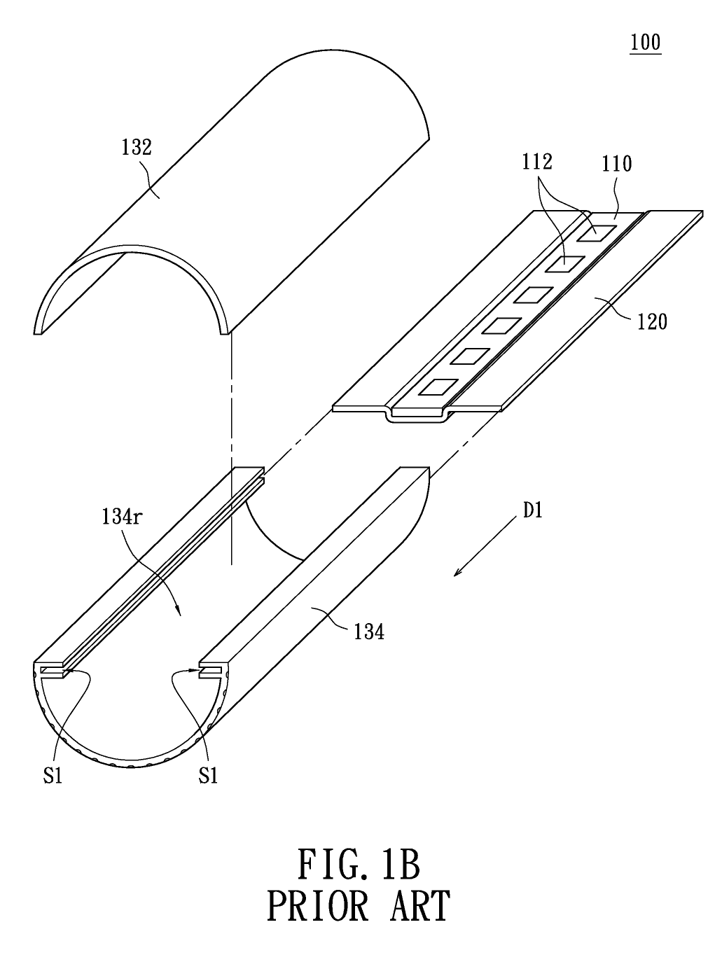

In addition, in the light-emitting device 200, the upper housing 232 and the lower housing 234 is combined together because the second fastening part 232b and the first fastening parts 234b are fastened each other. Thus, the upper housing 232 and the lower housing 234 both are directly combined together without applying adhesive for sticking. Comparing with conventional combination of the upper housing 132 and the lower housing 134 via adhesive (referring to FIGS. 1A and 1B), the assembly of the light-emitting device 200 can skip the adhesive for sticking to upper housing 232 and the lower housing 234, so as to reduce the cost of material in process.

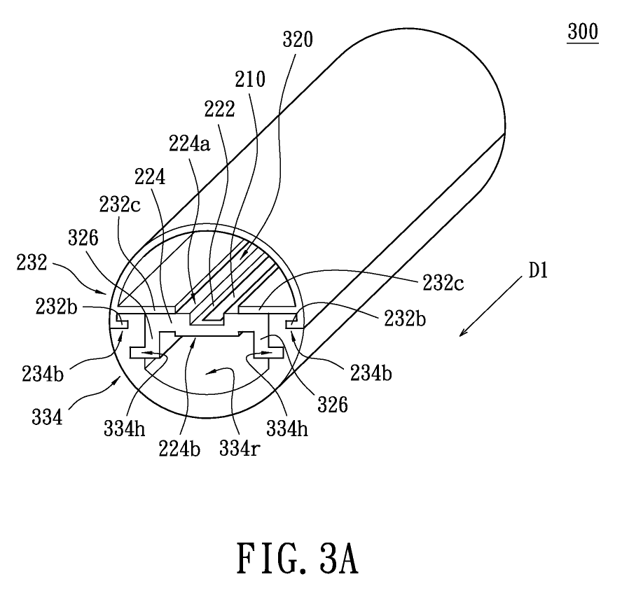

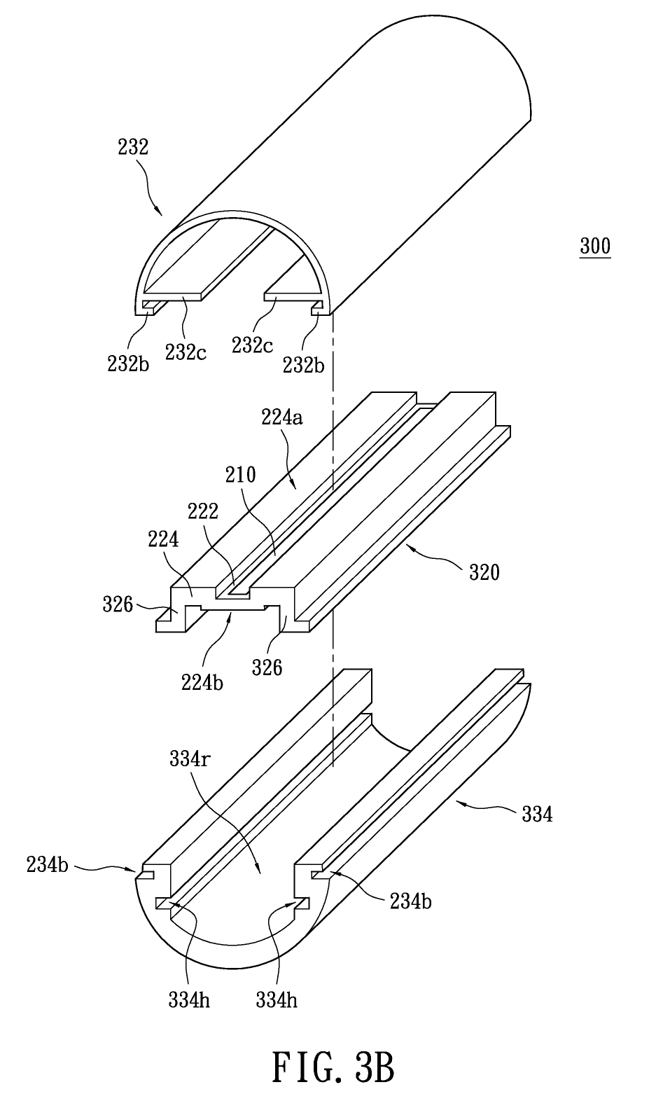

FIG. 3A illustrates a perspective view of a light-emitting device according to the second embodiment of the invention, and FIG. 3B illustrates a explode view of the light-emitting device in FIG. 3A. Referring to FIG. 3A and FIG. 3B, a light-emitting device 300 in the embodiment includes a light-emitting component 210, a supporting frame 320, an upper housing 232, and a lower housing 334. The function of both light-emitting devices 300 and 200 are the same, and the structure of both light-emitting devices 300 and 200 are similar.

For example, the lower housing 334 and the supporting frame 320 both also extend along the direction D1, and the lower housing 334 has a capacious recess 334r and a pair of first fastening parts 234b. The first fastening parts 234b are all fastening slots and can be fastened the second fastening part 232b of the upper housing 232 so that the upper housing 232 is combined with the lower housing 334.

Accordingly, the supporting frame 320 also includes a disposing region 222 and a holding part 224 located except the disposing region 222. The disposing region 222 is inward the surface of the holding part 224, and the light-emitting component 210 is disposed on the disposing region 222. Additionally, the pressing part 232c included by the upper housing 232 is also used to press the holding part 224 of the supporting frame 320.

However, the light-emitting devices 300 and 200 are different. In detail, the supporting frame 320 further includes a pair of hookers 326, and a pair of fastening slot 334h is set in the capacious recess 334r, where the fastening slots 334h are located in two corresponding sidewalls of the capacious recess 334r. The hookers 326 extend outward from two sides of the holding part 224 and correspond to the fastening slots 334h respectively. Specifically, the hookers 326 all protrude from the lower surface 224b of the holding part 224, but not from the upper surface 224a. Thus, the inserting members 226 only extend downward from the lower surface 224b.

When assemble the supporting frame 320 and the lower housing 334, the hookers 326 may be inserted entirely in the capacious recess 334r, and each of the ends of the hookers 326 can insert in one of the fastening slots 334h so that the hookers 326 are fastened the fastening slots 334h respectively, as shown in FIG. 3A. Because the hookers 326 and the fastening slots 334h are fastened each other, the supporting frame 320 is fixed in the capacious recess 334r. Therefore, the supporting frame 320 and the lower housing 334 can be combined together.

In conclusion, by the insertion of the inserting members in the inserting slots, or the fastening of the hookers in the fastening slots, the supporting frame can be fixed in the capacious recess of the lower housing, so as to finish the assembly between the supporting frame and the lower housing. Therefore, the supporting frame can be combined with the lower housing firmly. Comparing with prior art, the assembly between the supporting frame and the lower housing according to the invention is fairly simple and easy. Even if the length of the light-emitting device is to long, the supporting frame is not easy to be stuck in the lower housing. Thus, the invention can reduce the difficulty of assembling the light-emitting device to speed up the process, and the invention is helpful for mass production of the light-emitting devices.

The descriptions illustrated supra set forth simply the preferred embodiments of the present invention; however, the characteristics of the present invention are by no means restricted thereto. All changes, alternations, or modifications conveniently considered by those skilled in the art are deemed to be encompassed within the scope of the present invention delineated by the following claims.

What is claimed is:

1. A light-emitting device comprising:
a lower housing having a capacious recess and a pair of first fastening parts, wherein the capacious recess is located between the first fastening parts;
a supporting frame comprising a disposing region for the light-emitting component and the holding part located except the disposing region, wherein the supporting frame is disposed in the capacious recess;
a light-emitting component disposed on the disposing region; and
an upper housing having a pair of second fastening parts, wherein the upper housing cover the supporting frame and the light-emitting component by fastening between the second fastening parts and the first fastening parts.

2. The light-emitting device according to claim 1, wherein the disposing region is inward in a surface of the holding part.

3. The light-emitting device according to claim 2, wherein the lower housing further comprises a pair of inserting slots parallel to each other in a region between the capacious recess and the first fastening parts.

4. The light-emitting device according to claim 3, wherein the supporting frame further comprises a pair of inserting members extending from two sides of the holding part, and the supporting frame is fixed in the capacious recess by insertion of the inserting members in the inserting slots.

5. The light-emitting device according to claim 2, wherein a pair of fastening slots is set in the capacious recess, and the fastening slots are located in two corresponding sidewalls of the capacious recess respectively.

6. The light-emitting device according to claim 5, wherein the supporting frame further comprises a pair of hookers extending from two sided of the holding part, and the supporting frame is fixed in the capacious recess by fastening of the hookers in the fastening slots.

7. The light-emitting device according to claim 1, wherein the lower housing further comprises a pair of inserting slots parallel to each other in a region between the capacious recess and the first fastening parts.

8. The light-emitting device according to claim 7, wherein the supporting frame further comprises a pair of inserting member extending from two sides of the holding part, and the supporting frame is fixed in the capacious recess by insertion of the inserting members in the inserting slots.

9. The light-emitting device according to claim 1, wherein a pair of fastening slots is set in the capacious recess, and the fastening slots are located in two corresponding sidewalls of the capacious recess respectively.

10. The light-emitting device according to claim 9, wherein the supporting frame further comprises a pair of hookers extending from two sided of the holding part, and the supporting frame is fixed in the capacious recess by fastening of the hookers in the fastening slots.

11. The light-emitting device according to claim 1, wherein the upper housing further has a pair of pressing parts used for pressing the holding part.

12. The light-emitting device according to claim 11, wherein the upper housing and the lower housing are each in the shape of a bar and each have a long axis and a short axis, and the upper housing and the lower housing all extend along the long axis.
